(19) United States
(12) Patent Application Publication
(10) Pub. No.: US 2005/0167342 A1
(43) Pub. Date: Aug. 4, 2005

(54) Method and device for processing postal articles

(76) Inventors: Carsten Vullriede, Hodenhagen (DE); Dieter Stumm, Grossefehn (DE); Gunther Meier, Reinheim (DE); Jurgen Helmus, Bonn (DE); Peter Fery, Zwingenberg (DE)

Correspondence Address: Marshall Gerstein & Borun, 6300 Sears Tower, 233 South Wacker Drive, Chicago, IL, 60606-6357, US

(21) Appl. No.: 10/492,954

(22) PCT Filed: Oct. 15, 2002
(86) PCT No.: PCT/DE02/03886

(30) Foreign Application Priority Data
Oct. 16, 2001 (DE) 101 50464.0

(51) Int. Cl. G06F 17/00; B07C 5/00

(52) U.S. Cl. 209/584; 209/900; 705/401

(57) ABSTRACT

Disclosed herein are a method and device for processing postal articles. According to the disclosure, the method includes automatically verifying whether a postal article has an expected prepayment and placing a verification on the postal article where the postal article has the expected prepayment.

### DESCRIPTION

The invention relates to a method for processing mailpieces, whereby the mailpieces are sorted by at least one automated sorting installation.

The invention also relates to a device that is suitable for carrying out the method.

The invention is based on the objective of determining, in the most reliable manner possible, mailpieces for which insufficient payment or no payment at all has been made.

According to the invention, this objective is achieved in that an automated checking procedure is carried out to ascertain whether the mailpiece has the expected postage and in that the completion of the checking of the mailpiece is marked by applying a code onto the mailpiece.

The payment assurance code is a marking that contains information on the result of each checking procedure that has been performed.

As a matter of principle, any payment assurance codes can be used. However, it has been found that the use of 2-digit payment assurance codes is suitable for recording all relevant payment assurance events and for integrating them into the further processing of the mailpieces, especially their sorting.

The use of such a payment assurance code can serve for further process control, for example, to systematically divert mailpieces in case of suspicion of fraud, or else to direct them to additional checking steps that differ from each other and that are a function of the payment assurance code. Moreover, the application of a payment assurance code makes it possible to ensure that a mailpiece only undergoes the payment assurance procedure once and/or that it is only recorded one single time in a mailpiece recording system.

For this purpose, it is especially advantageous that, in processing the mailpiece, a processing machine checks whether the mailpiece is marked with a payment assurance code.

An effective recording of all mailpieces that avoids double recording can be advantageously achieved in that data record components of the mailpieces that are not marked are recorded in a data processing system.

Such a processing step is, for example, a preliminary sorting in a mail center for incoming mail and in a mail center for outgoing mail.

Another processing step is, for example, a fine sorting in a mail center for incoming mail and in a mail center for outgoing mail.

Additional advantages, special features and practical refinements of the inventions ensue from the subclaims and from the following presentation of preferred embodiments of the invention.

The depicted execution forms of the method and embodiments of the device allow the recording and utilization of mailpiece-related data for the process control and for the execution of the processing steps as a function of the acquired data.

The payment assurance system according to the invention records all machine-readable mailpieces. When an uncoded mailpiece is coded as it passes through the machine, the data is stored in the payment assurance system. When a coded mailpiece is fed into the machine, then data is only recorded if an after-coding has been applied. The recognition of already existent coding is carried out by checking means which, by checking at least one surface, ascertain whether the mailpiece contains a code.

An especially suitable means for checking is offered by the expanded utilization of automation in the mail centers in order to obtain more detailed information for each automatically processed mailpiece. The result is, on the one hand, the additional diverting of mailpieces into “payment assurance compartments”. On the other hand, data from the reading and checking procedures in the machines is collected and kept on hand for the processes involving each automatically processed mailpiece.

An especially important feature is the optimization of the procedures in the mail centers and in all of the adjacent areas.

The invention makes it possible to acquire information for numerous, preferably for all, payment modalities that are possible for the mailpieces.

The checking of the types of postage can be carried out in various checking steps that are adapted to the particular type of postage.

The checking of postage generated by means of sender franking machines (SFM) is preferably carried out as follows:

First of all, the type of postage is identified and checked, in the most automated way possible.

It is especially advantageous to identify and check the type of postage in an address reading machine (ARM) or in an integrated reading and video coding machine (IRVM).

Mailpieces that, during the execution of the payment assurance process, deviate from an expected pattern, generate a payment assurance warning. Such mailpieces are handled separately, in particular, they are diverted locally from the mail sequence at a suitable place. It is especially suitable to divert them to the fine sorting machines.

Diverting the mailpieces to a fine sorting machine has the advantage that the fine sorting machine has more compartments available for the differently diverted mailpieces. This makes it possible to selectively divert the mailpieces involving different scenarios, for example, approximately 10, that have to be considered within the context of payment assurance.

When mailpieces are examined that have postage that was generated with sender franking machines, preferably all of the postage imprints are recorded.

An especially advantageous local checking of mailpieces that have been franked with sender franking machines is carried out with the criteria of the machine sorting programs, especially retroactively, optionally manually and on the basis of a positive/negative file.

The checking of mailpieces having digital postage indicia allows an especially effective checking of the proper franking of the mailpieces, thanks to the large volume of information contained in the digital postage indicia.

Due to the preferred modality of generating such digital postage in personal computers (PC), this franking modality is referred to below as PC franking. The embodiments, however, also apply to other digital postage indicia that can be generated, for example, by means of suitable large-scale printers or by franking machines that are configured for printing digital postage indicia.

Another advantage of checking the authenticity of digital postage indicia is the possibility of an automated identification and checking of the type of postage.

In particular, mailpieces are locally diverted into a sorting machine, especially into a fine sorting machine. Here, mailpieces that trigger a payment assurance warning within the scope of a checking procedure are diverted.

The further process steps take place essentially according to the preceding example.

For the payment assurance, the mailing data of the customers who frank their mailpieces by means of PC franking is compiled and supplied in compressed form. The supply of data, for example, customer data, positive and negative file, is to be integrated into the application database franking and into the Postage Point. This is where the mailing data is associated with the customer data.

The various checking methods are embodiments of a process, involving the recording of the individual mailpiece, the subsequent coding of the mailpiece as a function of the result of a step of a payment assurance method and, if applicable, the diverting of mailpieces that are suspected of non-compliance with the prescribed postage requirements.

An especially advantageous embodiment of the invention is characterized in that each mailpiece is only read once in the payment assurance system in order to prevent the mailing data from being recorded twice.

Taking preferred operational sequences into consideration, the following processes for machine-readable and machine-processable mailpieces have been defined:
When an uncoded mailpiece—franking modalities “sender franking machine (SFM)” or “PC franking (PC-F)”—is coded as it passes through the machine, the data is recorded for the payment assurance system.
When a coded mailpiece is fed into the machine, no recording is carried out for the payment assurance system (unless an after-coding has been applied).
The recognition of an already existent coding is ensured by the technical capabilities at hand.
Special rules apply in the case of linear code scanning.

No coding takes place in the operation mode “LCS OFF” (linear code scanning OFF). However, the postage indicium is read, evaluated and the result is recorded for the payment assurance system. In this case, mailpieces that generate a payment assurance warning can be diverted into a preliminary sorting compartment of the address reading machine (ARM).

The processing of the mailpieces in mail centers is shown below. Fundamentally, the depicted processing of the mailpieces is suitable for all mail centers.

The initial processing of a mailpiece in a mail sorting installation, especially in an address reading machine that is integrated into such an installation, results in the recording in the payment assurance system. The coding here depends on the target information and on the machine readability. The mail volumes in the reject compartment of the address reading machine, for example, are not recorded for payment assurance data. Subsequently, processing is carried out once again in the integrated reading and video coding machine (IRVM) or in the video coding machine (VCM). In this embodiment, at the end of the processing in the integrated reading and video coding machine or video coding machine, the mail volume in the reject compartment is not recorded for the payment assurance system in the outgoing mail center (OMC) operation.

After the last run, the mailpieces in the reject compartment of the integrated reading and video coding machine or video coding machine go to the residual manual sorting station.

Mailpieces with a payment assurance warning that are returned to the conveying sequence are preferably sorted in the integrated reading and video coding machine or video coding machine by the sorting program of the fine sorting machine (FSM).

Preferably, this is done in that the address reading machines and the fine sorting machines, or rather the integrated reading and video coding machines, are operated in a special mode that suppresses the sorting according to the payment assurance code contained in the code (“payment assurance (PA) OFF”).

It is likewise advantageous for the fine sorting machines (FSM), in which there are compartments for diverting the mailpieces with payment assurance features, to be provided with the function “payment assurance (PA) OFF”.

The processing of uncoded mailpieces with
residual manual sorting (RMS)
E+1 COOP mailpieces (LR pre-sorting)
mailpieces for address reading machine or integrated reading and video coding machine (incoming mail center—IMC)
   by means of the address reading machines, or the integrated reading and video coding machines, in the incoming mail centers results in recording in the payment assurance system of the incoming mail center, as long as they are coded. In this case, the coding depends on the target information and on the machine readability.

The decision as to whether a mailpiece is coded or uncoded is made by a pre-barcode reader that is integrated into the sorting installation.

It is especially advantageous for mailpieces that are already coded not to be recorded once again in the payment assurance system and, at the same time, to ensure that all of the uncoded mailpieces are (retroactively) recorded whenever possible.

It is advantageous to ensure that all payment assurance warnings that become necessary within the scope of the coding in the incoming mail center are encrypted with codes for the positions T1 and T2 that are different from the coding in the outgoing mail center. It is advantageous to also provide the function “payment assurance (PA) OFF” for the sorting and coding aggregates in the incoming mail center as well.

The mail volumes in the reject compartment of the sorting installation are not recorded for the payment assurance system and they are transported to the residual manual sorting station in the incoming mail center (IMC).

For a mail volume that was processed in the outgoing mail center (OMC) without linear code scanning and that was already recorded for the payment assurance system in the outgoing mail center, it applies that operational processing in the incoming mail center is only allowed to be carried out in the residual manual sorting station or by means of the sorting program “IMC LCS OFF”, since otherwise—due to the lack of the master code—recording in the system for additional information about mailpieces (AIM) and coding in the incoming mail center would be carried out again.

The mail volume from linear code scanning OFF programs in the outgoing mail center has to arrive at the incoming mail center in appropriately marked mail containers (MCnr) so that they can be distinguished from the mailpieces that have been recorded by the sorting installation of the incoming mail center. A sorting program “IMC LCS OFF” would prevent data from being recorded twice for the system for additional information about mailpieces because here the recording in the system for additional information about mailpieces would be switched off.

The checking steps described below are especially well-suited for carrying out the individual checking modalities.

The mailpieces are fed in a readable manner to a unit of the sorting installation, for example, a coding machine. The pre-barcode reader checks whether the mailpiece has a complete barcode. Mailpieces with complete barcodes enter the normal conveying sequence and are not recorded in the system for additional information about mailpieces. With all of the other mailpieces, the image of each mailpiece is transmitted to the image management module (IMM) and to the connected sender franking machine and 2D barcode reading unit. The image management module and the reading unit check the presented image. If it is a mailpiece with a sender franking machine (SFM) imprint, then the SFM identification and the SFM postage indicium are read.

If the sender franking machine imprint or parts thereof cannot be read, then a payment assurance warning is automatically coded and the mailpiece is diverted into the “SFM identification not readable” or “SFM postage indicium not readable” payment assurance compartments in the fine sorting machine. If the sender franking machine imprint (SFM identification and the SFM postage indicium) was read, then a procedure checks whether the sender franking machine identification has been recorded in a negative file or in a positive file and/or if the mailpiece has insufficient postage.

If the sender franking machine identification is in the negative file, then a payment assurance warning is coded and the mailpiece is diverted into the “SFM negative file” payment assurance compartment in the fine sorting machine.

If the sender franking machine identification is not in the negative file, then a procedure checks whether it is in the positive file. If the sender franking machine identification is not in the positive file, then a payment assurance warning is coded onto the mailpiece and the mailpiece is diverted into the “SFM not in positive file” payment assurance compartment in the fine sorting machine.

If the sender franking machine identification is in the positive file, then the amount of postage is checked. If the mailpiece has insufficient postage, then a payment assurance warning is coded onto the mailpiece and the mailpiece is diverted into the “SFM insufficient postage” payment assurance compartment in the fine sorting machine.

If the sender franking machine identification is not in the negative file but rather in the positive file, and if there is sufficient postage, then the mailpiece is coded without a payment assurance warning and it is fed into the normal conveying sequence.

In a preferably local database, all of the mailpieces identified as coming from a sender franking machine are recorded and the identification is registered with the appertaining postage. This data is supplied for the evaluation and issuing of the local production report.

In a local payment assurance system, a production report is issued daily, it is augmented by the results of an after-processing of the mailpieces, for example, of a local database, with the following content:

1. Time axis (evaluation after the beginning or end of the shift with a window of time of approximately 15 minutes)

2. Fine sorting machine (machine data)

3. Number of mailpieces per payment assurance event (by machine/after-processing)

4. Number of mailpieces per payment assurance compartment (by machine/after-processing)

5. Payment assurance codes

6. Additional information:
Number of the mail center
Date of issue
Beginning and end of the recording (time of day)

The local reports are transmitted to a central database (central system for additional information about mailpieces) every workday after the distribution has been completed and after the input of the supplementary entries.

In a central payment assurance unit, for example, a central database, essentially the appertaining data of several processing centers is stored and, for each sender franking machine identification, a customer production report having the following content is drawn up:

1. Time axis, for example, on the basis of the processing cycles in a mail center

2. Sender franking machine identification

3. Customer data (Uniform Customer and Product (UCP) number, name, address)—the data is made available by the franking database

4. Franking data, including the number of after-processing procedures per payment assurance amount

5. Optionally, payment assurance events and diverting data, including after-processing

6. Display of mail volume and production, including after-processing

The data of the customer production report is transmitted to the franking database in order to issue the production account report.

For each sender franking machine identification, the franking database automatically compresses its own data as well as the data that has been transmitted by the central system for additional information about mailpieces every workday:
cumulative postage amount spent
cumulative amount of the paid value cards/value charges.

On a fixed schedule, the franking database compares the sum of the stamped amounts and the sum of the paid value cards/value charges for each sender franking machine identification read-in during the specified reporting period. If the results of the comparison between the read-in and the paid amounts exceed certain defined limit values, then the franking database automatically exports the data of that particular sender franking machine identification into an “alarm file” that is evaluated and further processed.

Moreover, the appertaining customer data is entered into the negative file so that it can be updated daily and transmitted to the local payment assurance system via the central payment assurance system.

Mailpieces that appear to have a digital postage indicium (PC-F) are presented to the advanced color recognizer (ACR). The advanced color recognizer analyzes the front of the mailpiece and compares patterns in an attempt to recognize a familiar type of postage (SFM, PC-F, etc.)

If PC-franking as the franking modality is recognized, the mailpiece is aligned in Compartment 1 or 2 so as to be readable for the further processing in the coding machines.

The mailpieces are fed to the coding machine so as to be readable. The pre-barcode reader checks whether the mailpiece has a complete barcode.

Mailpieces with complete barcodes enter the normal conveying sequence and are not recorded in the system for additional information about mailpieces. With all other mailpieces, the image of each mailpiece is forwarded to a central image management module (IMM) and to the connected sender franking machine and 2D-barcode reading unit. The image management module and the reading unit check the presented image. If it is a PC-franked mailpiece, the 2D-barcode is read.

If the 2D-barcode cannot be read, then a payment assurance warning is automatically coded and the mailpiece is diverted into the “PC-F negative file/barcode not readable” payment assurance compartment in the fine sorting machine.

Once the 2D-barcode has been read, and after the decryption of the cryptostring, the following checking procedures are carried out:
checking the PC-franking version
checking the Postage-ID
comparing the license number with the negative file
comparing the hash values
checking the date in the 2D-barcode
checking the minimum postage

If the PC-franking version is invalid, then a payment assurance warning is coded and the mailpiece is diverted into the “PC-F version/date/insufficient postage” payment assurance compartment in the fine sorting machine.

If the PC-franking version is valid, then the Postage-ID is checked. If the postage-ID is invalid, then a payment assurance warning is coded onto the mailpiece and the mailpiece is diverted into the “PC-F suspicion of forgery” payment assurance compartment in the fine sorting machine.

If the Postage-ID is valid, it is automatically compared to the negative file. If the postage-ID is in the negative file, then a payment assurance warning is coded onto the mailpiece and the mailpiece is diverted into the “PC-F negative file/barcode not readable” payment assurance compartment in the fine sorting machine.

If the license number is not in the negative file, the hash value is compared. If the hash value is not in order, a payment assurance warning is coded onto the mailpiece and the mailpiece is diverted into the “PC-F suspicion of forgery” payment assurance compartment in the fine sorting machine.

If the hash value is in order, then the date in the 2D-barcode is checked. If the date in the 2D barcode differs by more than one day from the actual date, then a payment assurance warning is coded onto the mailpiece and the mailpiece is diverted into the “PC-F version/date/insufficient postage” payment assurance compartment in the fine sorting machine.

If the date in the 2D barcode is valid, then the minimum postage is checked. If the mailpiece has insufficient postage, a payment assurance warning is coded onto the mailpiece and the mailpiece is diverted into the “PC-F version/date/insufficient postage” payment assurance compartment in the fine sorting machine.

The system recognizes the amount of the postage from the barcode and compares it to the stored values.

If the 2D-barcode of the PC-franked mailpiece was readable, if the PC-franked version and the Postage-ID are valid and if there is no entry in the negative file, if the hash value and the date are valid and the postage is sufficient, then the mailpiece is coded without a payment assurance warning and it is fed into the normal conveying sequence.

Mailpieces for which a manual reading and checking procedure with a hand-held scanner confirms that the Postage-ID is invalid or that the hash value comparison is not correct, are correctly diverted. The mailpieces are taken out of the conveying sequence for evidentiary purposes.

Mailpieces for which a manual reading and checking procedure with a hand-held scanner confirms that the mailpiece has insufficient postage are returned to the sender or else they receive the necessary supplementary postage and are delivered to the recipient.

Mailpieces for which a manual reading and checking procedure with a hand-held scanner confirms that the Postage-ID is supplied in the negative file are removed from the conveying sequence.

In a preferably local database, all mailpieces identified as PC-F are recorded and registered. This data is provided for the evaluation and issuing of the local production report.

In a local payment assurance unit that is especially provided with a local database (local system for additional information about mailpieces), a production report—augmented by the results of an after-processing of the mailpieces—is automatically drawn up, for example, daily by the person who checks for compliance with the General Terms and Conditions, and this report has the following content:

1. Time axis (evaluation after the beginning or end of the shift with a window of time of preferably at least 15 minutes)

2. Fine sorting machine (machine data)

3. Number of mailpieces per payment assurance event (by machine/after-processing)

4. Number of mailpieces per payment assurance compartment (by machine/after-processing)

5. Payment assurance codes

6. Additional information:
Number of the mail center
Date of issue
Beginning and end of the recording (time of day)

The transmission of the local reports to the central system for additional information about mailpieces is preferably carried out every workday after the distribution has been completed and after the input of the supplementary entries.

In a central payment assurance unit, which preferably interacts with a central database, essentially the appertaining data of several processing centers is stored and, for each license number, a customer production report having the following content is drawn up:

7. Time axis (=mail center-day)

8 License number

9 Customer data (UCP number, name, address)—the data is supplied by the franking database

10. Franking data, including the number of after-processing procedures per payment assurance amount

11. Optionally payment assurance events and diverting data, including after-processing

12. Display of mail quantity and production, including after-processing

In order to be able to draw up a production-postage amount report in the franking database, the spent postage amounts calculated on the basis of the utilization profile from the Postage Point are transmitted to the database and collected there. The time intervals depend on when the customer last had contact with the Postage Point (at the latest every three months).

Once the most recently requested postage amount of every single customer has been transmitted from the Postage Point to the franking database and once the production reports for each customer are available, sorted according to license number, then the franking database automatically generates a daily updated production postage amount report, sorted according to license number:

1. License number

2. Cumulative franking amount of all mailpieces recorded in the customer production report (production value)

3. Spent postage amount calculated on the basis of the utilization profile

4. Postage amount from the Postage Point

Preferably daily, the cumulative franking amount of all mailpieces recorded in the production report for each customer is compared to the postage amount from the Postage Point and the results are stored. If the production value according to the report is higher than the postage amount, then the franking database automatically exports the customer data into an “alarm file”. Moreover, the customer data is entered into the negative file so that this file is updated daily and can be transmitted via the central payment assurance system—central system for additional information about mailpieces—to the local payment assurance system—local system for additional information about mailpieces.

A local checking means is available for the processing of the diverted mailpieces. The local checking means consists of a data acquisition unit, a graphic display unit, one or more input units, a scanner and optionally additional peripherals such as a printer for printing labels and mail scales.

This device can be employed individually in the direct vicinity of the alignment and sorting machines. The data feed or network feed takes place via existing interfaces (traffic lights) in the production.

Processing programs that are modularly adapted to the franking modalities (for example, sender franking machines and PC-franking) support the recording, evaluation and documentation of the detected franking modalities.

The connected hand scanners (wireless/hard-wired) provide information on the characteristics as well as on the decrypting of the 2D barcode with the support of a crypto-server.

The mail scales serve to check the payment, a (planned) label printer allows the production of stickers for returning mailpieces, or for printing labels to collect additional postage due.

The embodiments shown here are intended only by way of example.

The depicted method for processing mailpieces and the device shown can have a large number of different embodiments in order to fulfill different functions.

In all of the embodiments, the use of payment assurance codes provides effective protection of the postal service provider against misuse and it links this protection to comprehensive data protection of the customer of the postal service provider while ensuring full compliance with postal confidentiality requirements.

| Term | Definition |
|---|---|
| 2D barcode | Two-dimensional matrix code that is printed onto the |
| | mailpiece and that contains mailpiece-specific information |
| | in machine-readable form. |
| Sender | Actual contractual partner of Deutsche Post. Party |
| | required to make the postal conveyance payment. Does |
| | not have to be identical to the party mailing or producing |
| | a mailpiece. |
| ACR | → Advanced color recognizer |
| Advanced color recognizer | Technical device for recognizing stored postage stamps |
| | (and optionally other types of postage) on the basis of a |
| | simple image. |
| Sender-recipient relation | Who sends mailpieces within Germany to which postal |
| | code region? Who sends mailpieces abroad? |
| Sender-franked | Mailpieces that are printed with the postal conveyance |
| | payment by the mailing party, using a franking machine |
| | for purposes of payment. |
| Sender franking machine | Technical device for franking mailpieces. The required |
| | payment is printed directly onto the mailpiece. The frank- |
| | ing machine user buys a “credit” from the postal service |
| | provider. With each franking imprint, the credit is reduced |
| | by the amount set on the machine. |
| Sender postage cancella- | Cancellation of the postage stamp with an imprint by the |
| tion | producer prior to mailing (only for the Infopost and Info- |
| | letter products) |
| SFM identification | 7-character alphanumeric identification of the sender |
| | franking machine of a customer of the postal service pro- |
| | vider. The first position contains a letter that identifies the |
| | manufacturer of the machine, the next 6 characters iden- |
| | tify the customer of the postal service provider. |
| GT&C examiner | An employee in the mail center. |
| | During the operation, he checks whether the mailpieces |
| | that have been submitted for conveyance are in compli- |
| | ance with the “General Terms and Conditions (GT&C) of |
| | the Deutsche Post”. |
| ARM | Address reading machine |
| AM | Alignment and stamping machine |
| Address field | The area on an envelope that is detected by the reading |
| | means of the address reading machine/integrated reading |
| | and video coding machine in order to read the address |
| | (street, house number, P.O. Box, postal code and city) of |
| | the recipient. |
| Diverting | Mechanical diverting of certain mailpieces into a compart- |
| | ment intended for this purpose. |
| Barcode | Barcode with which the recipient address and the payment |
| | assurance warning is coded. |
| 2D barcode | Recognition feature of the PC-franking modality |
| 2D barcode reader | Reading device in the image management module (IMM) |
| | that can read, decrypt and check the barcode |
| Cash franking | Making a cash payment for a mailing at a branch of |
| | Deutsche post. The mailpieces receive a postage indicium |
| | as proof of payment. |
| Conveying sequence | Term for all of the processing steps that a mailpiece |
| | undergoes in the mail center. |
| BMF | Federal German Ministry of Finance: issuer of the postage |
| | stamp |
| Mailpieces | All mailpieces that are processed via the mail centers: let- |
| | ters, postcards, books, goods, Infopost/catalog, Info- |
| | letter/catalog, bulk mail, mail for the blind (free of charge) |
| Additional mail services | The sender can make use of one or more additional ser- |
| | vices for some products in exchange for payment of an |
| | additional fee. Additional services are: registered, drop-off |
| | registered, addressee-only, return receipt, C.O.D. These |
| | additional services call for a handling of the mailpieces |
| | that differs from the normal processing. |
| MC | Mail center |
| OMC window of time | The time that is available for a mail center to process the |
| | mailpieces until the vehicles leave (main sequence). |
| AMS | Additional mail services |
| CCCS | Customer Care Center Software; distribution information |
| | system that is used by the business-customer service |
| | (CallCenter) in Bielefeld, Germany for the documentation |
| | of communication with customers. |
| Hand-held sensor | Technical device for manually checking the authenticity |
| | of postage stamps |
| FRANKING database | The FRANKING database (FDB) contains customer-spe- |
| (FDB) | cific data of all sender franking machine and PC-franking |
| | customers, and it is the basis of the automatic payment |
| | assurance. |
| Direct Marketing Center | The Direct Marketing Centers handles customers with a |
| (DMC) | mail volume of up to 25,000 German marks per year. The |
| | objective of the Direct Marketing Center is to generate a |
| | larger volume of advertising mail. |
| DP franking | Data processing (DP) program of the customer that, after |
| | certain information has been entered, determines the |
| | amount to be paid for that particular mailpiece and prints |
| | this onto the mailpiece. The individual mailpieces are |
| | numbered consecutively. The total payment for a mailing |
| | is withdrawn from the customer's account by the compe- |
| | tent regional accounting center. |
| Mailing party | The producer of a mailpiece. Does not have to be identical |
| | to the sender. |
| MC for mailing | The mail center that is in the area where the postal cus- |
| | tomer mails his mailpieces. |
| Mailing date | The date on which the customer mails a mailpiece, for |
| | example, at a postal service branch. |
| Collection of fee for | Payment for the effort on the part of the Deutsche Post in |
| postage due | collecting the insufficient postage. |
| UCP no. | Uniform customer and product number. |
| Recipient | Addressee of a mailpiece. Not a contractual partner of the |
| | Deutsche Post. |
| Payment | The amount that has to be paid to the Deutsche Post for |
| | the service of conveying a mailpiece; types of postage |
| Date of recording | The date on which a mailpiece passes through the sorting |
| | machine |
| Investigation office | Organizational unit of the Deutsche Post; responsible for |
| | the preliminary investigation of incidents that are |
| | detrimental to the Deutsche Post and that are caused by |
| | internal persons (employees) and external persons. In |
| | criminal cases, it is the liaison between the Deutsche Post |
| | and the public prosecutor's office. |
| PA | Payment assurance: all measures that contribute to the |
| | Deutsche Post receiving the payment it is owed for the |
| | services it has provided. |
| PA compartment | Compartment of the fine sorting machine that is available |
| | for diverting mailpieces out of the payment assurance |
| | system. |
| Branch regional | Organizational unit of the Deutsche Post, liaison between |
| management | the franking machine manufacturer, the franking machine |
| | owners and the MAIL COMMUNICATION business- |
| | customer service. |
| Fluorescence | Component of postage stamps; chemical substance that |
| | becomes visible as a result of irradiation with ultraviolet |
| | light and that is needed in the stamping machines so as to |
| | recognize postage indicia and to align the mailpieces. |
| Franking | Postal term for the payment of the amount required for the |
| | conveyance of a mailpiece. |
| Franking modalities | Payment options for the conveyance of mailpieces. The |
| | following distinction is made: |
| | postage stamps, sender franking, cash franking, data |
| | processing franking, franking service, PC-franking |
| Postage indicium | Marking on a mailpiece indicating that the payment for |
| | the total mailing has been paid in cash at an office of the |
| | Deutsche Post. |
| | The postage indicium contains the name of the office. The |
| | value of the mailpiece payment is not indicated. |
| Franking imprint | Imprint applied onto the mailpiece by means of a franking |
| | machine as proof of payment. The franking imprint con- |
| | sists of: |
| | payment stamp showing the sender franking machine |
| | identification, the mailpiece payment, the words |
| | “Deutsche Post AG” or “Deutsche Bundespost” and the |
| | drawing of the Post Horn, the date stamp indicating the |
| | date and the agreed-upon mailing location (postal code |
| | and place), the advertising field of the sender. Infopost or |
| | Infoletters contain the supplement “postage paid” in the |
| | franking imprint or the product information. |
| | Currently, the imprint is applied in red ink. For purposes |
| | of better machine-readability, a more high-contrast blue |
| | ink will be used in the future. |
| Franking machine | Sender franking machine |
| FPIL | Franking party InfoLine (FPIL), a database analysis tool |
| | of the payment assurance in the Mail Business Division of |
| | the Deutsche Post. It utilizes the data of other Business |
| | Divisions acquired within the scope of the sender franking |
| | and organizes as well as compresses this data under the |
| | aspect of payment assurance. |
| FSM | Fine sorting machine |
| OL | Oversized letters |
| BCS | Business-customer service MAIL COMMUNICATION, |
| | in Bielefeld, Germany. |
| | Responsible for all contractual matters having to do with |
| | sender franking machines. Maintains the master data of |
| | the “franking” database. |
| Hand-held scanner | Technical device for reading a 2D barcode. It is employed |
| | for checking purposes with PC-franking if the barcode |
| | reader malfunctions or else for checking purposes. |
| Hash value | Function for encrypting data that is transmitted via the |
| | Internet |
| (Storage) history | The stored versions of files are archived separately and |
| | logically with their appertaining storage date. |
| IRVM | Integrated reading and video coding machine |
| IMM | Image Management Module |
| Transit time | The time duration for conveying a mailpiece from the |
| | time it is mailed by the customer to the time it is delivered |
| | to the recipient. The postal service has laid down certain |
| | transit times for its products as its quality target. |
| Transit time delay | Prolongation of the transit time due to certain events. |
| LCS | Linear code scanning |
| Local system | Here: local computer for additional information about |
| | mailpieces in each mail center |
| Marketing plan | In the marketing plan, target specifications are defined for |
| | the sales and turnover of each product of the Deutsche |
| | Post. |
| Master function | Central access to the local computer for additional |
| | information about mailpieces |
| Minimum franking value | Corresponds to the payment of the “cheapest” form of |
| | mailing. At the current time, this is Infopost Standard |
| | National = 0.47 German marks |
| Additional postage due | In case of insufficient postage: additional payment = |
| | collection fee + difference from the correct franking. As a |
| | matter of principle, insufficiently franked mailpieces are |
| | diverted in the outgoing mail center and returned to the |
| | sender. If no sender information is available, the mail- |
| | pieces are delivered with additional postage due. |
| Negative file | In dubious cases, the negative file contains certain sender |
| | franking machine identifications (if applicable, also |
| | permissible ones) and customer data of the PC-franking. |
| | This file is created and maintained centrally. |
| PC-F customer system | The PC-F customer system comprises the hardware and |
| | software that are used by the customer for PC-franking. |
| PC-F | PC-franking |
| PC-franking | New form of franking at the Deutsche Post with which |
| | customers can use a conventional PC with a printer and |
| | additional software and, if applicable, hardware as well as |
| | an Internet access in order to be able to print “digital post- |
| | age indicia” onto domestic letters, etc. |
| Postal code cluster | Individual postal codes will be combined into postal code |
| | clusters within the scope of the project for additional |
| | information about mailpieces in order to reduce the data |
| | stock and to render it more transparent. |
| Postage amount | The amount that is loaded electronically into a “wallet” in |
| | the PC-franking customer system and used for the produc- |
| | tion of postage indicia. |
| Positive file | The positive file contains all of the permissible sender |
| | franking machine identifications with the appropriate |
| | postal code according to the date stamp. It is provided |
| | centrally by the FRANKING database (FDB) every day |
| | and updated by the MAIL COMMUNICATION business- |
| | customer service, in Bielefeld, Germany. |
| Postage Point | The Deutsche Post makes a Postage Point available on the |
| | Internet through which postage amounts can be loaded. |
| Mail suppression | Unauthorized removal of mailpieces from the operating |
| | sequence; criminal offense. |
| Pre-barcode reader | Component of the mail sorting installation that scans all |
| | mailpieces for the presence of codes. This makes it possi- |
| | ble to avoid double coding as well as to apply after-coding |
| | by diverting the mailpiece into a separate compartment. |
| PS | Postage stamp; type of postage |
| RMS | Residual manual sorting |
| Key data (PC-F) | The key data consists of a random number and the |
| | specification ID. The specification ID contains informa- |
| | tion on the identity of the customer, on the specification |
| | itself and on the validity of the postage indicia produced |
| | with this specification. The key data is made available in |
| | the Postage Point. |
| Scoring model | Models that automatically trigger actions in case of |
| | significant changes. Example: if the utilization pattern of a |
| | customer changes, the distribution employee in charge |
| | should be notified. |
| SF | Super-fluorescence |
| SFS | Super-fluorescence sensor |
| Mailpieces without code | Mailpieces that have no address and payment assurance |
| | coding |
| S/Cmp | Standard/compact mailpiece |
| Mwc | Mailpiece without code |
| Super-fluorescence | Substance that makes it possible to check the authenticity |
| | of postage stamps by means of a super-fluorescence sen- |
| | sor or a hand-held sensor. |
| Super-fluorescence sensor | Technical device in the alignment machine that checks the |
| | authenticity of postage stamps. |
| Sales | Economic index: sales = quantity * unit price; here: |
| | 1. Value of the conveyed mailpieces (total of individual |
| | payments of all mailpieces that have been mailed by a |
| | customer) |
| | 2. Credit purchased from the Deutsche Post by the cus- |
| | tomer (e.g. purchased value cards for a certain franking |
| | machine) |
| Sales analysis | For individual customers, the following sums (sales) are |
| | compared: |
| | ”Value of the mailpieces that have been mailed” (sum of |
| | the postage values) and payments collected from the cus- |
| | tomer (e.g. purchased value charges for franking |
| | machines). |
| Insufficient postage | Shortfall of the payment required for a mailpiece accord- |
| | ing to the General Terms and Conditions. |
| | Example: |
| | the required payment for a standard letter is 1.10 German |
| | marks, but the mailpiece is only franked with 0.80 |
| | German marks. |
| VCM | Video coding machine |
| Verification | Verification by checking the correctness. The mailpieces |
| | that are automatically diverted out of the system are |
| | checked manually by the GT&C examiner to ensure that |
| | the diverting was correct. |
| Specification ID | Number generated in the Postage Point that contains |
| | information about the identity of the customer, about the |
| | specification and about the validity of the postage indicia |
| | produced with this specification. |
| Central distribution | Employee of the central distribution control department |
| controller | (Dept. 142) in the center. |
| AIM | Additional Information about Mailpieces |

1. A method for processing mailpieces, the method comprising:
(a) sorting the mailpieces by at least one automated sorting installation;
(b) carrying out an automated checking procedure to ascertain whether the mailpiece has the expected postage;
(c) applying a code onto the mailpiece to complete the checking Drocedure, wherein the checking procedure comprises checking whether the mailpiece is marked with a payment assurance code with a processing machine and in case the mailpiece had not already been provided with a payment assurance code, applying to the mailpiece the payment assurance code by the same processing machine.

2. The method of claim 1, further comprising recording data record components of the mailpieces that are not marked in a data processing system.

3. The method claim 1, wherein the sorting step (a) consists of preliminarily sorting the mailpieces in a mail center for incoming mail and in a mail center for outgoing mail.

4. The method of claim 1, wherein the sorting step (a) consists of a fine sorting the mailpieces in a mail center for incoming mail and in a mail center for outgoing mail.

5. The method of claim 1, wherein the automated checking procedure comprises checking whether the mailpiece has been franked with a certain type of postage.

6. A device for processing mailpieces comprising a unit for recording information that is present on at least one surface of the mailpieces, the unit comprising an image management module and a reading unit capable of checking the presence of a payment assurance code.

7. The device of claim 6, wherein the device comprises at least one computer for processing the mailpiece as a function of a marking applied onto the mailpiece, the marking indicating that the payment assurance has been effectuated.

8. A system for payment assurance, the system comprising:
(a) incoming mail centers; and,
(b) outgoing mail centers for a preliminary sorting of mailpieces for the incoming mail centers;
wherein the incoming and outgoing mail centers each comprise:
(i) several devices for processing mailpieces, wherein the devices are capable of checking the presence of a payment assurance code on the mailpiece, and the devices are each connected to
(ii) a unit for recording information present on at least one surface of the mailpieces.

9. The system of claim 8, wherein essentially all of the devices for processing mailpieces comprise a unit for recording information present on at least one surface of the mailpieces, an image management module, and a reading unit capable of checking the presence of a payment assurance code.

10. A system for payment assurance. the system comprising:
(a) a franking database capable of compiling its own data as well as data that has been transmitted bv a central payment assurance unit at pre-definable time intervals;
(b) a comparator that allows a comparison of
(i) a cumulative postage amount used for all of sender-franked mailpieces of a customer with
(ii) a cumulative amount of paid value cards and value charges.

11. The system of claim 10, wherein the comparator compares and determines a difference between the sum of the amounts of generated postage and the sum of the paid value cards and value charges for each sender franking machine identification read during a specific reporting period.

12. The system of claim 10 comprising a Processor that operates. when a limit value defined for a difference detected bv the comparator is exceeded, to perform at least one of automatically exporting the data of a corresponding sender franking machine identification into an “alarm file” and issuing an automatic warning report and performing an evaluation, a further processing, a storage of the comparison results per sender franking machine identification as well as the entering of the sender franking machine identification into the negative file are all carrioed out.

13. The system of claim 8 further comprising a comparator capable of carrying out a customer-related comparison of sales of all recorded PC-franked mailpieces with a postage amount from the Postage Point.

14. The system of claim 13, wherein the pre-definable time intervals is a workday for each customer.

15. The system of claim 13, wherein the comparator compares the cumulative franking amount of all recorded mailpieces to the postage amount from a postage point daily and determines the difference.

16. The system of claim 13 further comprising a processor adapted to determine whether a production value exceeds the postage amount and, if the production value exceeds the postage amount, generating a warning report, and performing an evaluation, a further processing, a storage of the comparison results per license number as well as entering the customer data into the negative file, so that this data can, at predefined time intervals, be transmitted from the central payment assurance unit to the local payment assurance unit.

17. The system of claim 14, wherein the data comprise cumulative postage amount spent.

18. The system of claim 14, wherein the data comprise postage amount from the postage point.
